(19) United States
(12) Patent Application Publication
(10) Pub. No.: US 2015/0028570 A1
(43) Pub. Date: Jan. 29, 2015

(54) AIRBAG TEAR SEAMS FORMED BY IRRADIATION

(71) Applicant: Faurecia Interior System, Inc., Auburn Hills, MI (US)

(72) Inventors: Brian Jacobs, Auburn Hills, MI (US); Mathew Barr, Clarkston, MI (US)

(21) Appl. No.: 13/949,347

(22) Filed: Jul. 24, 2013

(51) Int. Cl. B60R 21/2165

(52) U.S. Cl. CPC B60R 21/2165
USPC 280/728.3; 156/257

(57) ABSTRACT

A method of making a vehicle interior panel includes irradiating a covering layer material in a manner that reduces the strength of the material while preserving the thickness of the covering layer. An irradiated portion of the covering layer is arranged to at least partially overlie an airbag door region of an underlying substrate to help define the location of an airbag tear seam. The irradiation process can be carried out using an electron beam or ultraviolet light. Natural or synthetic organic materials may have their chemical structures altered by irradiation in a manner that reduces the strength of the material, thus reducing or eliminating the need for stress-concentrating features in covering layers and enabling non-visible tear seams to be formed in high strength materials like leather.

### TECHNICAL FIELD

The present disclosure relates generally to vehicle interior panels for use over airbags and, more particularly, to tear seams formed in vehicle interior panels.

### BACKGROUND

Vehicle airbags are safety devices that deploy toward the interior of a vehicle to help protect its occupants from injury in the event of a crash. Airbags may be concealed behind or beneath an interior panel during normal vehicle operation until such an event. When the airbag deploys, it typically does so through a deployment opening formed in or around the interior panel. The deployment opening may be pre-formed in the panel, the panel may move away to reveal the opening, or the opening may be formed during airbag deployment at a pre-determined location in the panel. Where formed during airbag deployment, one or more layers of the panel are sometimes made to include cuts, scores, notches, or other features intended to locally reduce the thickness of the layer so that the layer splits or tears along a line of reduced thickness. Efforts have been made to conceal such thickness-reducing features from view to reduce their effect on vehicle interior aesthetics.

U.S. Patent Application Publication No. 2005/0274160 to Muller et al. describes an attempt to make these types of features less visible in leather coverings. The method includes drying the leather prior to making an undercut in the back side of the leather. The leather has a locally reduced thickness at the undercut that defines a tear line when the airbag opens. The dried leather has a reduced moisture content, which is said to make the location of the undercut less visible over time than if the undercut is made in leather with higher moisture content.

### SUMMARY

In accordance with one or more embodiments, a method of making a vehicle interior panel for use over an airbag includes the steps of: (a) providing a covering layer comprising a material having a strength; (b) irradiating the covering layer in a manner that reduces the strength of the material and preserves the thickness of the covering layer where irradiated; and (c) disposing a decorative covering that includes the covering layer over a vehicle interior panel substrate so that an irradiated portion of the covering overlies at least a portion of an airbag deployment region of the substrate.

In accordance with one or more embodiments, the step of irradiating the covering layer includes electron beam irradiation.

In accordance with one or more embodiments, the step of irradiating the covering layer includes ultraviolet irradiation.

In accordance with one or more embodiments, the method includes the step of forming a stress-concentrating feature in the decorative covering at the irradiated portion of the covering layer.

In accordance with one or more embodiments, the method includes irradiating the covering layer along an inner surface of the covering layer that faces toward the substrate.

In accordance with one or more embodiments, the method includes irradiating the covering layer along an inner surface of the covering layer that faces toward the substrate and along an opposite outer surface of the covering layer.

In accordance with one or more embodiments, the method includes irradiating one of the opposite inner and outer surface of the covering layer more than the other.

In accordance with one or more embodiments, the material is leather.

In accordance with one or more embodiments, the method includes the step of masking the covering layer during the step of irradiating the covering layer to define the irradiated portion.

In accordance with one or more additional embodiments, a vehicle interior panel for use over an airbag includes a substrate having an outer surface and an airbag deployment region, and a decorative covering disposed over the outer surface of the substrate. The decorative covering includes a layer of material with a reduced strength portion, and the reduced strength portion at least partially overlies the airbag deployment region. A tear seam is formed in the decorative covering and arranged so that the decorative covering tears along the reduced strength portion of the layer of material during airbag deployment.

In accordance with one or more embodiments, the layer of material is leather.

In accordance with one or more embodiments, the leather includes a corium layer, and the corium layer has a different chemical structure at the reduced strength portion than at locations away from the reduced strength portion.

In accordance with one or more embodiments, the tear seam includes a stress-concentrating feature formed in the decorative covering along the reduced strength portion.

Within the scope of this application it is envisaged that the various aspects, embodiments, examples, features and alternatives set out in the preceding paragraphs, in the claims and/or in the following description and drawings may be taken independently or in any combination thereof. For example, features disclosed in connection with one embodiment are applicable to all embodiments, except where there is incompatibility of features.

### DESCRIPTION OF THE DRAWINGS

One or more embodiments will hereinafter be described in conjunction with the appended drawings, wherein like designations denote like elements, and wherein:

FIG. 1 is a partial cutaway view of an instrument panel with an airbag module installed therebeneath;

FIG. 2 is a schematic illustration of one example of an irradiation process being performed on a covering layer;

FIG. 3 is a schematic illustration of another example of the irradiation process, including a mask;

FIG. 4 is a schematic illustration of another example of the irradiation process, including a mask with a U-shaped opening;

FIG. 5 is a line plot showing the strength of a covering material at various levels of irradiation;

FIG. 6 is a cross-sectional view of the panel of FIG. 1, where the decorative covering includes a covering layer with a reduced strength portion;

FIG. 7 is a cross-sectional view of another version of the panel of FIG. 1, where the covering layer includes a different reduced strength portion; and

FIG. 8 is a cross-sectional view of another version of the panel of FIG. 1, where the entire covering layer is irradiated.

### DETAILED DESCRIPTION OF EMBODIMENT(S)

As described below, an irradiation process can be used to reduce the strength of the material of one or more covering layers of a vehicle interior panel in a manner that preserves the thickness of the covering layer. Reducing the physical strength of the material can reduce or eliminate the need to include stress-concentrating features such as grooves, cuts, or scores in the covering layer(s). An irradiated portion of the covering layer is arranged with respect to the airbag so that a tear seam is formed therealong, causing the covering layer to tear or split along the irradiated portion during airbag deployment. The irradiation process can be carried out using an electron beam, ultraviolet light, or other forms of irradiation. Natural or synthetic organic materials, such as the corium layer of leather, may have their chemical structures altered by irradiation in a manner that reduces the strength of the material.

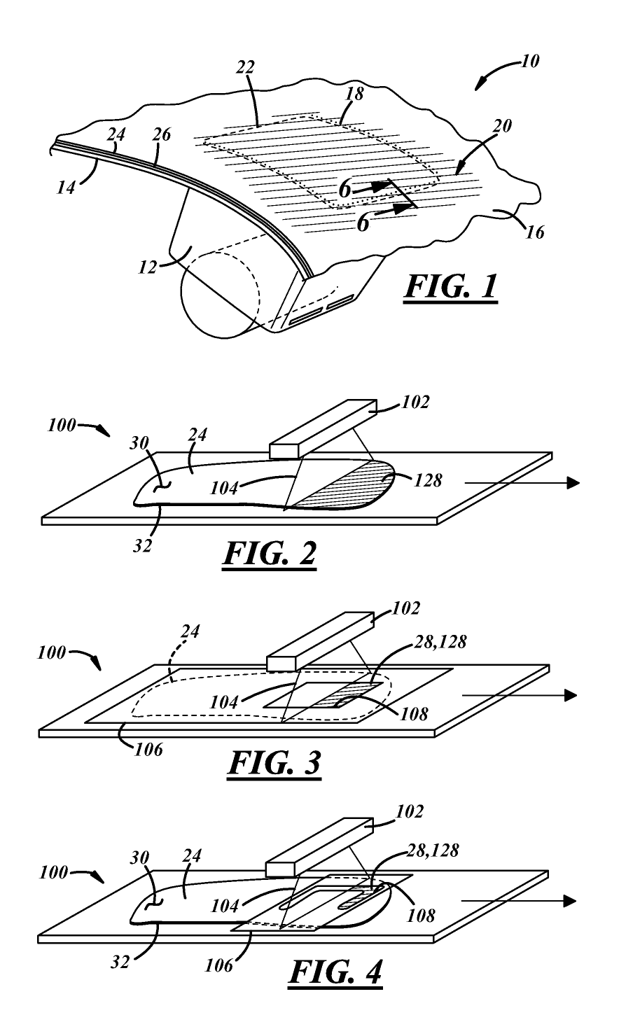

Referring now to FIG. 1, there is shown a cut-away view of one embodiment of a vehicle interior panel 10 with an airbag module 12 installed therebeneath. The portion of the panel 10 shown in the figure is the passenger side of a vehicle instrument panel, but these teachings are applicable to any vehicle interior panel for use over an airbag, such as a steering wheel panel, seat panel, door panel, etc. The illustrated panel 10 includes a substrate 14, a decorative covering 16, and a tear seam 18 formed over an airbag deployment region 20 of the substrate. The substrate 14 is configured to have a deployment opening formed therethrough at a pre-determined location 22 during airbag deployment, represented in FIG. 1 by dashed lines in a generally rectangular shape. For example, the substrate 14 may have a score line, notch, groove, or other stress concentrator(s) formed therein that causes the substrate to break along the stress concentrator(s) to form an airbag door when the underlying airbag deploys. Alternatively, the substrate 14 may have a molded-in airbag door, an airbag door attached via a hinge or tether, or an opening through which an underlying airbag door opens during airbag deployment. The opening revealed by the airbag door is the deployment opening of the substrate.

The substrate 14 and covering 16 may be made using known materials and techniques. For example, the substrate 14 may be constructed from an injection-molded thermoplastic material, such as glass-filled polypropylene, or any other material or combination of materials that helps define the overall shape of the panel 10 and supports the decorative covering 16. The covering 16 may provide a desired aesthetic to the vehicle interior and may include any number of covering layers, such as a decorative layer 24 (e.g., leather or a textured polymeric film) as the outermost and visible layer, and one or more inner layers 26 (e.g., a foam cushioning layer, a spacer fabric or 3D-fabric layer, and/or other layers) sandwiched between the substrate 14 and the decorative layer 24. The covering layers 24, 26 may be laminated or otherwise attached together prior to being disposed over and/or attached to the substrate, or each covering layer may be separately disposed over the substrate to form the finished panel 10. In some embodiments, the decorative layer 24 is the only layer of the decorative covering 16.

The tear seam 18 is a feature formed in the decorative covering 16 along which the covering splits or tears during airbag deployment to form a deployment opening through the covering. In this example, the tear seam 18 is depicted as a dotted line and has a U-shape, but it could be in some other shape, such as an H-shape or an X-shape, and the shape may correspond to the shape of an underlying airbag door. The tear seam 18 may include any of various types of stress-concentrating features, such as cuts, scores, notches, grooves and/or perforations designed to localize deployment-induced stress in the covering layer(s) so the covering 16 tears at a predictable location during airbag deployment. Though such stress-concentrating features may be formed in the covering 16 to help define the tear seam 18, the teachings presented herein can reduce or eliminate the need for such features.

The airbag deployment region 20 is an area of the substrate 14 over which the decorative covering 16 is subjected to airbag deployment-induced stress and is represented in FIG. 1 by the hatched area. Region 20 thus encompasses the deployment opening location 22 and extends therebeyond as shown, as the covering 16 is subjected to deployment-induced stress outside of the deployment opening to some limited extent. In this example, where an underlying airbag door pivots open at the top side of the U-shape of the tear seam 18, region 20 extends further beyond the deployment opening 22 at the lower side of the U-shape than at the top, as shown. The entire tear seam 18 lies over the airbag deployment region 20. Though not shown explicitly in FIG. 1, at least one of the covering layers 24, 26 may include a reduced strength portion 28 that at least partially overlies the airbag deployment region 20, and at least a portion of the tear seam 18 is located along the reduced strength portion of the material.

As used herein, a reduced strength portion is a portion of any material where the physical strength of the material is locally reduced compared to the surrounding material. For purposes of this disclosure, “strength” is used in its sense as a material property indicating the ability of the material to withstand an applied stress without failure. For instance, two tensile specimens made from the same material but with different cross-sectional areas will fail at different applied tensile loads—e.g., a structural beam made from steel requires more tensile force to break than a thin wire made from the same grade of steel. But the strength of the steel material in each tensile specimen is the same. As applied to decorative covering materials and tear seams, the above-described stress-concentrating features (e.g., cuts, scores, grooves, etc.) do not serve to reduce the physical strength of the materials in which they are formed. Rather, they provide locations of reduced thickness where the local stress is higher due to the reduced cross-section. When airbag forces are applied from beneath such coverings, the strength (i.e., failure stress) of the material is reached at the stress-concentrating features before it is reached elsewhere along the covering, and the covering tears along the stress-concentrating features. In contrast, the reduced strength portion described herein reaches its failure stress before other portions of the material due at least in part to its lower strength, with or without the aid of stress-concentrating features. The reduced strength portion can be produced by an irradiation process, some examples of which are described below.

FIG. 2 is a schematic illustration of one example of an irradiation process 100 that can be used to form an irradiated portion 128 of a decorative covering. In this example, an irradiation source 102 directs an irradiating beam 104 toward a covering layer, which in this case is decorative layer 24. The covering layer 24 moves beneath the irradiation source 102 so that the beam 104 impinges at least a portion of the layer. In other embodiments, the decorative layer 24 and beam 104 may move relative to one another in some other manner to irradiate the desired portion of the covering layer 24. As provided, the covering layer 24 includes a material with an associated strength, such as a tensile strength, tear strength, impact strength, etc. Irradiating the covering layer as shown can reduce the strength of the material while preserving the thickness of the covering layer where it is irradiated. In the example of FIG. 2, the beam 104 is sized so that the entire covering layer 24 is irradiated as it passes beneath the beam. The beam 104 may be in the form of a curtain or line, as shown in FIG. 2, or it may have some other shape (e.g., cylindrical, prismatic, etc.).

Irradiation is energy in particle or wave form and is transferable to the covering layer without physical contact between the source 102 and the covering layer. Examples of irradiation include electromagnetic irradiation, such as ultraviolet irradiation, and electron beam or e-beam irradiation. Irradiation can reduce the strength of certain materials, such as organic or natural materials. While not intending to be bound by theory, it is believed that irradiation reduces the strength of such materials by breaking covalent bonds of polymer chains in the material, whether the polymer is synthetic or natural (e.g., cellulose or collagen). This molecular level change in the polymer network of the material can thus reduce the strength of the material while preserving the thickness of the covering layer. Some forms of irradiation may also cause new covalent bonds to be formed within the material, such as cross-links between polymer chains, or between broken polymer chains, which can lower the impact strength of the material by localized embrittlement.

In embodiments where the entire covering layer is irradiated, as in FIG. 2, the irradiated material does not necessarily include a reduced strength portion. That is to say that the material may have a reduced strength compared to its pre-irradiated strength, but no portion of the material is reduced in strength compared to another portion. FIGS. 3 and 4 illustrate embodiments of the irradiation process 100 that include a masking step, in which the irradiated portion 128 is a reduced strength portion 28. In the example of FIG. 3, a mask 106 is located over and moves with the covering layer 24 as it is exposed to the irradiating beam 104. The mask 106 has an opening 108 in the shape of the desired reduced strength portion 28 so that only the portion of material accessible through the opening in the mask is irradiated. In this case, the opening 108 is rectangular and results in a rectangular reduced strength portion 28 in the covering layer 24 that may be located over the airbag deployment region of a panel substrate and along the desired tear seam location. In the example of FIG. 4, the mask opening 108 is generally U-shaped and results in a U-shaped reduced strength portion 28 that may be located over the airbag deployment region of a panel substrate along the desired tear seam location.

In the illustrated embodiments of the irradiation process 100, the covering layer 24 has opposite inner and outer surfaces 30, 32. The inner surface 30 is the surface intended to face toward the panel substrate 14 (FIG. 1) when disposed thereover, and the outer surface 32 faces away from the substrate. Where the irradiated covering layer is the decorative layer 24 as shown, the outer surface 32 is the visible decorative surface of the finished interior panel. One or both of the inner and outer surfaces 30, 32 may be exposed to the irradiating beam 104. In the illustrated examples, the inner surface 30 facing toward and is exposed to the irradiating beam 104, and the outer surface 32 is facing down and away from the beam. In some embodiments, the process 100 includes exposing the outer surface 32 of the covering layer 24 to the irradiating beam 104, and in other embodiments, the process includes exposing both surfaces 30, 32 to the irradiating beam, either simultaneously or sequentially.

The total amount of irradiation delivered to the covering layer may be divided equally for delivery to the opposite surfaces 30, 32, or a higher amount of irradiation may be delivered at one surface than at the other. Division of the irradiation dosage among the opposite surfaces of the covering layer may depend on a number of factors, including material type, color, form of irradiation, or other factors. For instance, some forms of irradiation may affect the strength of the material in the covering layer in a manner that is depth dependent—i.e., the strength of the material at the exposed surface of the layer of material may be affected more than the material within the thickness of the material layer, or vice versa. In some cases, the color of the material layer may be affected by the irradiation and it may be desirable to deliver a higher portion of the total irradiation via the inner surface 30 than via the outer surface. In some materials, the strongest portion of the material layer before irradiation may be nearer one of the surfaces 30, 32 than the other, and some or all of the total amount of irradiation is delivered to the material at the surface closest to the strongest portion of the material layer.

The irradiation process 100 may also be used to reduce the strength of the material of non-decorative layers, such as inner layer(s) 26 of FIG. 1. In some cases, the irradiation process 100 is performed on the covering layer after it is already attached to another layer, such as an inner layer or substrate layer. The covering layer can be disposed over the substrate as a layer of the decorative covering either before or after it is irradiated to make the vehicle interior panel. The irradiated portion 128 overlies at least a portion of the airbag deployment region of the substrate.

As noted above, one form of irradiation is electron beam (e-beam) irradiation, in which the irradiating beam 104 is an electron beam. In such cases, the irradiation source 102 is an e-beam system and may include various components not illustrated, such as a power supply, filament, acceleration tube, scanning coil, vacuum chamber, and/or a cooling gas source. Suitable e-beam systems are available from PCT Engineered Systems (Davenport, Iowa) under the Broadbeam family of products. The irradiation provided by an e-beam system is measured in kilogray (kGy), which is the amount of ionizing energy absorbed per unit mass of material (kJ/kg). This quantity is dependent on the accelerating potential of the system (kV), the exposure time of each unit mass (i.e., the speed of the covering layer relative to the electron beam), the nature of the material being irradiated, and other factors. An irradiation dose in a range from 100 to 2000 kGy may be used to reduce the strength of a covering layer material. In one embodiment, an irradiation dose in a range from 300 to 1200 kGy may be delivered to the covering layer material to reduce the material strength. Within this range, an e-beam irradiation dose of at least 450 kGy may sufficiently reduce the strength of the material, and a dosage in a range from 500 to 1000 kGy may be preferred for certain materials. The higher the e-beam dose, the more likely an organic material will discolor, burn, or become brittle. In some cases, these effects may be acceptable, such as when the irradiated layer is not a decorative layer, for example.

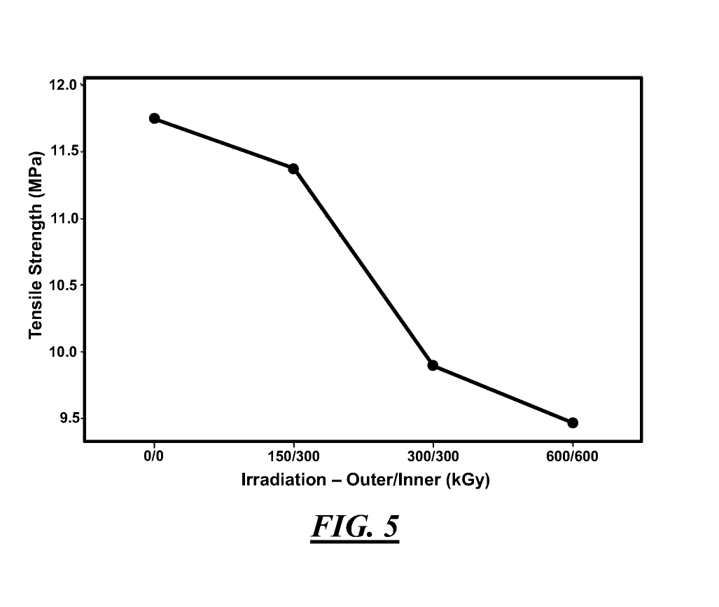

FIG. 5 is a line plot of ultimate tensile strength of one example of a covering layer material as a function of irradiation dosage. In this experimental example, the covering layer is leather, and the irradiating beam is an e-beam. Each plotted data point represents an average of ten or more tensile strength measurements performed on covering layer material samples, each with a thickness of 1.1 mm and a width of 50 mm. An e-beam system set at 300 kV was used to irradiate the material samples. In some leather materials, the material is believed to be strongest nearer the outer decorative surface than nearer the opposite inner surface, so a portion of the total amount of irradiation delivered to each sample was delivered via the decorative surface, but this is not always necessary. Samples were irradiated at: 450 kGy (150 kGy via the decorative outer surface and 300 kGy via the opposite surface); 600 kGy (300 kGy via each of the opposite surfaces); and 1200 kGy (600 kGy via each of the opposite surfaces). This data confirms that irradiating the covering layer can reduce the strength of the material while preserving the thickness of the covering layer.

Another form of irradiation is ultraviolet irradiation, in which the irradiating beam is ultraviolet light in a wavelength range from 10 to 400 nm. Ultraviolet light is capable of breaking chemical bonds and may thus reduce the strength of organic materials as described above. Various types of UV light sources are known, including fluorescent, filament-based, and laser light sources. Laser light sources are widely used in laser cutting or scoring processes to form the earlier-described stress-concentrating features, but do so by delivering highly focused energy along a panel component to remove material by vaporizing it where exposed to the laser beam. The irradiation taught herein is capable of reducing the strength of the material in a manner that preserves the thickness of the material. For example, a particular wavelength of ultraviolet light may be useful to break carbon-carbon bonds or carbon-oxygen bonds found in natural or synthetic polymers without burning the material away. Skilled artisans may identify other useful irradiation processes that use other parts of the electromagnetic spectrum (e.g., x-ray).

Reducing the strength of a covering layer material by irradiation may be particularly useful with natural materials such as leather. While leather is often a desirable material for use in vehicle interiors, non-visible tear seams have long proven difficult to form in a leather covering layer, for a variety of reasons. In some cases, leather is too strong for stress-concentrating features such as cuts, scores, grooves, etc. to function properly as part of an airbag tear seam. As a natural material, leather is also less consistent as an engineering material, often having unwanted piece-to-piece and intra-piece thickness and/or strength variations, directionally dependent mechanical properties, and other inconsistencies that are not as common in synthetic materials. Where stress-concentrating features are used in leather to define the tear seam, the residual wall thickness of the leather required for proper tear seam function is sometimes so small that it is easily noticeable at the decorative side of the leather. Irradiated leather addresses this by having a reduced material strength. Leather as a decorative material generally includes an outer grain layer, which provides the visible surface of the material and gives leather its grained appearance, and an underlying corium layer. The corium layer is generally responsible for the high strength of leather, and includes a three-dimensional network of intertwined fibrous material composed largely of collagen. The irradiation process is believed to break down the collagen and thereby reduce the strength of the corium layer. The irradiation process thus alters the chemical structure of the corium layer. Though the exact mechanism of the alteration is not clear, it is believed that covalent bonds within the collagen fibers are broken.

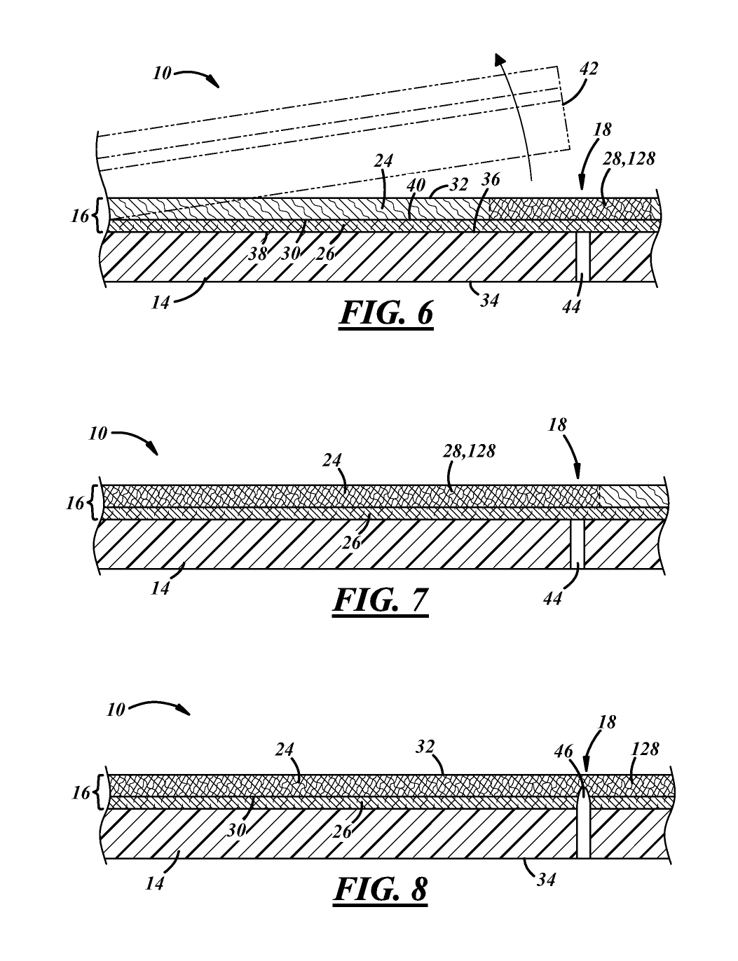

FIGS. 6-8 are cross-sectional views of a portion of the vehicle interior panel 10 of FIG. 1, illustrating different examples of the decorative covering 16 with an irradiated portion 128 and/or a reduced strength portion 28. With reference to FIG. 6, the decorative covering 16 includes decorative layer 24, depicted as a leather material layer, over inner layer 26, depicted as a spacer fabric. The substrate 14 has opposite inner and outer surfaces 34, 36, and the covering 16 has opposite inner and outer surfaces 38, 32. The outer surface 32 of the covering 16 is provided by the outer surface of the decorative layer 24. The inner surface 38 of the covering 16 is provided by the inner surface of the inner layer 26. The inner surface 30 of the decorative layer 24 opposes an outer surface 40 of the inner layer 26. In each of the examples of FIGS. 6-8, the decorative layer 24 includes an irradiated portion 128 (shown in a different cross-hatch pattern) that at least partially overlies the airbag deployment region 20 (FIG. 1) of the substrate 14. The decorative layer 24 is one continuous sheet of the same material, but the irradiated portion 128 has a reduced strength relative to its pre-irradiated strength. The panel 10 is shown in phantom during airbag deployment in FIG. 6. When the airbag deploys from beneath the panel 10, the decorative covering 16 tears along the tear seam 18, at least a portion of which is located along the irradiated portion 128, as part of the panel 10 becomes an airbag door 42 that opens in the direction of the unnumbered arrow.

In the panel 10 in FIG. 6, the irradiated portion 128 is the reduced strength portion 28 of the material of the decorative layer 24. This embodiment corresponds to the irradiation process depicted in FIG. 4, where the reduced strength portion 28 is shaped and configured to generally follow the perimeter of the airbag door 42 in a U-shape, though other processes may be employed with or without the mask. In this particular example, the decorative covering 16 does not include a stress-concentrating feature designed to cause the deployment opening to form there. The reduced strength portion 28 is shown having a width that spans the distance between the moving portion (airbag door 42) and the non-moving portion of the substrate. But the reduced strength portion 28 could also be formed along a thin line or path similar to conventional cuts or scores to more narrowly define the location of the tear seam 18. The substrate 14 includes a slot or cut 44 formed completely therethrough in the cross-sectional view of FIG. 6. Some substrates 14 include a plurality of through-holes or slots 44 separated by solid bridging material between adjacent slots. These types of slots 44 are considered stress-concentrating features in the substrate 14, as the stress in the substrate is concentrated at the small cross-section of the bridging material during airbag deployment.

FIG. 7 is a cross-sectional view of another embodiment of the panel 10 in which the irradiated portion 128 is the reduced strength portion 28 of the material of the decorative layer 24. This embodiment corresponds to the irradiation process depicted in FIG. 3, where the reduced strength portion 28 is shaped and configured to generally overlie the deployment opening formed about the airbag door during airbag deployment. This reduced strength portion 28 may be somewhat less location dependent than that of FIG. 6. The inner layers 26 of FIGS. 6 and 7 do not include a stress-concentrating feature or a reduced strength portion, but may include either or both.

FIG. 8 is a cross-sectional view of another embodiment of the panel 10 in which the irradiated portion 128 includes the entire decorative layer 24. This embodiment corresponds to the irradiation process depicted in FIG. 2, where there is no definable reduced strength portion along the layer of material, even though the strength of the material may be reduced relative to the pre-irradiated strength. In this embodiment, there is no need to align the irradiated portion 128 with any underlying substrate feature, as the irradiated portion overlies the entire substrate 14, including the airbag deployment region 20 (FIG. 1). The illustrated panel 10 also includes a stress-concentrating feature 46 extending into the decorative layer 24. The stress-concentrating feature 46 shown here is a laser-cut hole extending from the inner surface 34 of the substrate 14, through the thickness of the substrate and the inner layer 26, and partially through the decorative layer 24 at its inner surface 30. A plurality of laser-cut holes 46 may be formed as part of the tear seam 18. This type of feature 46 can be formed after the covering 16 is disposed over and/or attached to the substrate 14 to form the panel 10. The stress-concentrating feature 46 can be used in conjunction with any covering layer, with or without an irradiated portion and with or without a reduced strength portion. Each covering layer 24, 26 may or may not include a separately formed stress-concentrating feature 46. A covering layer with reduced strength material can allow the stress-concentrating feature 46 to be formed less aggressively. In other words, not as much stress concentration is required when the material of the covering layer has been reduced in strength—i.e., the residual wall thickness of the decorative layer can be larger than with full-strength material, thus reducing the likelihood that the stress-concentrating feature 46 will be visible at the outer surface 32.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of making a vehicle interior panel for use over an airbag, comprising the steps of:
(a) providing a covering layer comprising a material having a strength;
(b) irradiating the covering layer in a manner that reduces the strength of the material and preserves the thickness of the covering layer where irradiated; and
(c) disposing a decorative covering that includes the covering layer over a vehicle interior panel substrate so that an irradiated portion of the covering overlies at least a portion of an airbag deployment region of the substrate.

2. The method of claim 1, wherein step (b) includes electron beam irradiation.

3. The method of claim 1, wherein step (b) includes ultraviolet irradiation.

4. The method of claim 1, further comprising the step of forming a stress-concentrating feature in the decorative covering at the irradiated portion of the covering layer.

5. The method of claim 1, wherein step (b) includes irradiating the covering layer along an inner surface of the covering layer that faces toward the substrate in step (c).

6. The method of claim 1, wherein step (b) includes irradiating the covering layer along an inner surface of the covering layer that faces toward the substrate in step (c) and along an opposite outer surface of the covering layer.

7. The method of claim 6, wherein one of said surfaces is irradiated more than the other.

8. The method of claim 1, wherein the material is leather.

9. The method of claim 1, further comprising the step of masking the covering layer during step (b) to define the irradiated portion of step (c).

10. A vehicle interior panel for use over an airbag, comprising:
a substrate having an outer surface and an airbag deployment region;
a decorative covering disposed over the outer surface of the substrate, the decorative covering comprising a layer of material with a reduced strength portion, wherein the reduced strength portion at least partially overlies the airbag deployment region; and
a tear seam formed in the decorative covering and arranged so that the decorative covering tears along the reduced strength portion of the layer of material during airbag deployment.

11. A vehicle interior panel as defined in claim 10, wherein the layer of material is leather.

12. A vehicle interior panel as defined in claim 11, wherein the leather includes a corium layer, and the corium layer has a different chemical structure at the reduced strength portion than at locations away from the reduced strength portion.

13. A vehicle interior panel as defined in claim 10, wherein the tear seam further comprises a stress-concentrating feature formed in the decorative covering along the reduced strength portion.
